(19) United States
(12) Patent Application Publication
(10) Pub. No.: US 2003/0218660 A1
(43) Pub. Date: Nov. 27, 2003

(54) Liquid supplying tube in use for liquid jet device and liquid jet device provided with the same

(75) Inventors: Hitoshi Matsumoto, Nagano (JP); Toshio Kumagai, Nagano (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/374,526

(22) Filed: Feb. 27, 2003

(30) Foreign Application Priority Data
Feb. 28, 2002 (JP) P2002-053905
Feb. 3, 2003 (JP) P2003-026154

(51) Int. Cl. B41J 2/175

(52) U.S. Cl. 347/85

(57) ABSTRACT

A liquid supplying tube for supplying liquid from a liquid tank to a liquid jet head mounted on a carriage includes at least one long elastic member, having a first face and a second face which are extended in a longitudinal direction thereof and at least one film member, hermetically joined to the first face and the second face of the elastic member so as to form a liquid supplying passage.

### BACKGROUND OF THE INVENTION

The present invention relates to a liquid supplying tube for supplying liquid from a liquid tank, which is disposed on a liquid jet device body, to a liquid jet head mounted on a reciprocatively movable carriage, and a liquid jet device having the same.

An ink jet recording device for printing an image or the like on a paper sheet by ejecting ink drops onto the paper sheet is known for a liquid jet device for ejecting a liquid to a target.

The ink jet recording device includes a liquid jet head (referred to as a recording head) which is mounted on a carriage and reciprocatively moved in a main scan direction, and a feeder for feeding a target (referred to as a recording sheet) in a sub-scan direction orthogonal to the main scan direction. The recording head ejects liquid drops (referred to as ink drops) onto a recording sheet in accordance with jet data (referred to as print data) to thereby print on the recording sheet. The liquid jet device is provided mainly for home use. In many recording devices of this type, each liquid tank (referred to as an ink tank) for supplying ink to the recording head is removably attached to the carriage having the recording head mounted thereon.

In the recording device of the on-carriage type in which an ink tank is mounted on the carriage, it is difficult to use an ink tank of a large capacity. Therefore, to execute relatively massive printing, it is required to frequently replace the ink tank with a new one. Accordingly, manual operation is needed for the tank replacing operation, and further running cost is inevitably increased.

To cope with this, this type of the recording device provided for business use, for example, employs the following ink supplying system (off-carriage type). An ink tank of a large capacity is located in the device main body side. Ink is supplied from the ink tank to the recording head mounted on the carriage through a flexible liquid supplying tube (referred to as an ink supplying tube).

In the recording device of the off-carriage type, as the printer size (printable sheet size) is larger, a length of the drawing of the ink supplying tube is longer, and the dynamic loss (pressure loss) is larger in the liquid supplying tube ranging from the ink tank to the carriage. This necessitates the use of an ink supplying tube having a large inside diameter for each ink supplying tube.

In addition, most of the ink supplying tubes used in the recording device of the off-carriage type have each an annular cross section. Accordingly, its flexural rigidity is basically large. Further, when the ink supplying tube having a large inside diameter is employed, the flexural rigidity of the tube is further increased. Accordingly, to overcome the flexural rigidity of the tube, the necessity arises of further increasing a drive force for the carriage. With increase of the flexural-rigidity, the tube must be designed to have a large bending diameter. In any case, the result is a further size increase of the recording device.

The ink supplying tube involves the following problems. It is necessary to suppress evaporation of water content as a major component of the ink solvent. Further, air is dissolved into the ink in the ink supplying tube to thereby reduce a degree of degassing in the ink. To cope with this, one may take a measure of increasing the thickness of the ink supplying tube. Where the tube thickness increase measure is taken, the flexural rigidity of the tube is more increased.

To improve the anti-water permeability and gas barrier properties of the ink supplying tube, there is a proposal to use two or more layers to construct the ink supplying tube. Where a multi-layer construction is introduced into the tube annular in cross section, it is basically unavoidable to increase the flexural rigidity. Where the measure to use two or more layers for the tube is employed, metal molds must be respectively used for forming those layers in the extrusion molding machine. This results in increase of cost to manufacture.

### SUMMARY OF THE INVENTION

It is therefore an object of the present invention to provide an liquid supplying tube in use for the liquid jet device in which a flexural rigidity of the ink supplying tube is reduced, and satisfactory anti-water permeability and gas barrier properties are realized at low cost, and to provide a liquid jet device provide with the liquid supplying tube.

In order to achieve the above object, according to the present invention, there is provided a liquid supplying tube for supplying a liquid from a liquid tank mounted on a carriage comprising:

at least one long elastic member, having a first face and a second face which are extended in a longitudinal direction thereof; and

at least one film member, hermetically joined to the first face and the second face of the elastic member so as to form a liquid supplying passage.

Preferably, the at least one long elastic member is a pair of elastic members which are arrayed in parallel, and the first face and the second face of the respective elastic members are opposite to each other. The at least one film member is a pair of film members, and the film members are hermetically joined to the first faces and the second faces of the elastic members respectively.

Preferably, the at least one long elastic member is a plurality of elastic members which are arrayed in parallel, the first face and the second face of the respective elastic members are opposite to each other. The at least one film member is a pair of film members, and the film members are hermetically joined to the first faces and the second faces of the elastic members respectively.

Preferably a damper function portion is provided at a downstream side of the liquid supplying passage.

Here, it is more preferable that the damper function portion is formed so as to recess a part of the elastic member.

Preferably, the film member is a stretch film member. Preferably, an inner face of the liquid supplying passage is constituted by a part of the film member and a part of the elastic member. A peripheral length of the part of the film member is longer than the part of the elastic member in a cross section orthogonal to a longitudinal direction of the liquid supplying passage.

Preferably, a thin film whose at least one of gas barrier properties and anti-water permeability is superior to that of the film member, are layered on the film member.

Preferably, the elastic member is comprised of elastomer.

Preferably, the film member is hermetically joined to the elastic member by heat welding process.

Preferably, the liquid supplying tube further comprising a connection member which has an opening communicated with the liquid supplying passage. The connection member is mounted to an end of the liquid supplying passage.

According to the present invention, there is also provided a liquid jet device, comprising:

a liquid tank, disposed on a main body of the liquid jet device;

a carriage, moving reciprocatively;

a liquid jet head, mounted on the cartridge; and

a liquid supplying tube, supplying liquid from the liquid tank to the liquid jet head, including:

at least one long elastic member, having a first face and a second face which are extended in a longitudinal direction thereof; and

at least one film member, hermetically joined to the first face and the second face of the elastic member so as to form a liquid supplying passage.

Preferably, the at least one long elastic member is a plurality of elastic members which are arrayed in parallel, and the first face and the second face of the respective elastic members are opposite to each other. The at least one film member is a pair of film members, and the film members are hermetically joined to the first faces and the second faces of the elastic members respectively, and the liquid supplying tube is connected the main body of the liquid jet device to the carriage in a state that a flat face of the liquid supplying tube is bent like U shape. In this case, the flat face of the liquid supplying tube except the bending part is oriented substantially parallel to a horizontal plane.

In the liquid supplying tube thus constructed, spaces defined by the long, flat elastic members and the film members hermetically joined to the elastic members are used as liquid supplying passages. The plurality of the long, elastic members are arrayed parallel to each other, and the film members are hermetically joined to first face, whereby a plurality of separate liquid supplying passages are formed in parallel and along a long, flat face.

Accordingly, by connecting the liquid supplying tube thus structured from the liquid jet device body to the carriage side, liquid to be jetted by the jet head are supplied to the jet head through a flat liquid supplying tube as a unit body. The liquid supplying tube is connected from a main body of a liquid jet device to a carriage in a state that the flat surface of the liquid supplying tube is bent like U, whereby the flat liquid supplying tube may smoothly be bent to reduce a flexural rigidity of the liquid supplying tube.

If the elastomer is used for the long elastic members forming the liquid supplying tube, the heat welding of a synthetic resin material constituting the elastomer to a synthetic resin material forming the film members is made easy. As a result, this contributes to reduce the cost to manufacture the liquid supplying tube of this type.

Thin films whose gas barrier properties and the anti-water permeability are superior to those of the film members, are layered (for example, laminated) on the film members in advance, whereby the resultant liquid supplying tube is given satisfactory gas barrier properties and the anti-water permeability. Accordingly, the manufacturing cost is further reduced when comparing with the conventional liquid supplying tube which uses the annular multi-layered structure in order to obtain the gas barrier properties and the anti-water permeability.

An flexible film members are used for the liquid supplying tube. This feature accrues to such a secondary advantage that a variation of liquid pressure caused when the liquid in the jet head receives an acceleration force caused by the reciprocal movement of the carriage is effectively suppressed by an elasticity of the flexible film members. In this respect, a liquid jet device in which the damper member for suppressing the liquid pressure variation is removed from the carriage, may be realized.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view showing an overall construction of a recording device using an ink supplying tube of a first embodiment according to the present invention;

FIG. 2 is a perspective view showing an outward appearance of the ink supplying tube used in the recording device shown in FIG. 1;

FIG. 3 is an enlarged, front view showing an end of the FIG. 2 ink supplying tube as viewed from an end thereof attached with connection members;

FIG. 4 is a cross sectional view showing the ink supplying tube taken on line A-A in FIG. 3 when viewed in a direction of an arrow;

FIG. 5 is a cross sectional view showing the ink supplying tube taken on line B-B in FIG. 4 when viewed in a direction of an arrow;

FIG. 6 is a cross sectional view showing a C part enclosed by a one-dot chain line in an enlarged fashion in FIG. 5;

FIG. 7 is a perspective view showing an end part of the ink supplying tube in a perspective state;

FIG. 8 is a perspective view showing a structure to give a part of the ink supplying tube a damper function;

FIGS. 9A and 9B are a cross sectional view and a perspective view of an ink supplying tube according to a second embodiment; and

FIGS. 10A and 10B are a cross sectional view and a perspective view of an ink supplying tube according to a third embodiment.

### DETAILED DESCRIPTION OF THE PREFERRED EMBODIMENTS

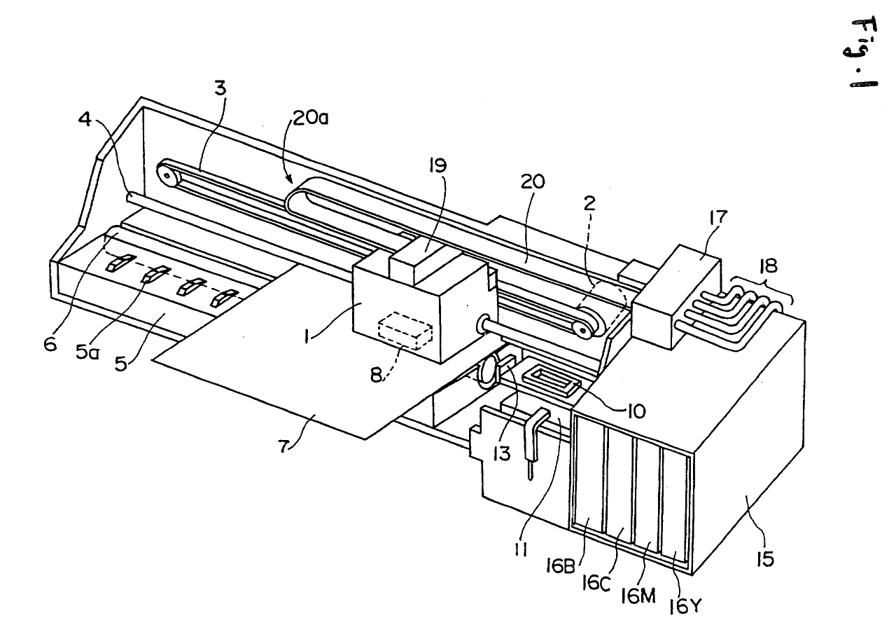

An ink jet recording device using an ink supplying tube according to the present invention will be described with reference to the accompanying drawings. FIG. 1 is a perspective view showing a basic construction of a main body of the recording device. In FIG. 1, reference numeral 1 designates a carriage. The carriage 1 is reciprocatively moved in the main scan direction which extends along a longitudinal direction of a sheet feeder 5, while being guided by a guide member 4 with the aid of a timing belt 3 driven by a carriage motor 2.

The sheet feeder 5 is provided with a sheet feed roller 6. A recording sheet 7, nipped between the sheet feed roller 6 and a follower roller (not shown), is transported by rotation of the sheet feed roller 6 in a sub-scan direction orthogonal to the main scan direction. A number of protrusions 5a are intermittently arrayed in the longitudinal direction on the upper surface of the sheet feeder 5. The recording sheet 7 is transported along the upper surfaces of the thus arrayed protrusions 5a.

An ink jet recording head 8, as indicated by a broken line, is mounted on the lower surface of the carriage 1, which faces the recording sheet 7. The recording head 8 ejects ink drops onto the recording sheet 7 at proper timings according to print data so as to print an image on the recording sheet 7.

Reference numeral 10 designates a capping device disposed in a non-print area (home position). When the recording head 8 moves to just above the capping device 10, the capping device 10 moves upward and seals a nozzle forming surface of the recording head (the lower surface of the recording head 8 in this embodiment). A suction pump 11 for applying a negative pressure to the inner space of the capping device 10 is disposed under the capping device 10.

During a period that the recording device is stopped, the capping device 10 functions as a cover which seals the nozzle forming surface of the recording head 8 and suppresses evaporation of the ink solvent. At the same time, a cleaning operation for the maintenance of the recording head on its ink drop ejecting function is also performed in a manner that a negative pressure is applied from the suction pump 11 to the recording head 8 to thereby suck ink from the recording head.

As shown in FIG. 1, a wiping member 13, shaped like a strip made of an elastic material, e.g., rubber, is disposed in a print area adjacent to the capping device 10. When the carriage 1 is reciprocatively moved to the capping device 10, the wiping member horizontally moves to and from the moving path of the recording head when necessity arises, and wipes the nozzle forming surface of the recording head 8 to clean the surface.

As shown in FIG. 1, a tank holder 15 is provided on the side end (right end in FIG. 1) of the recording device. Ink tanks are removably attached to the tank holder 15 from the front side of the recording device. The ink tanks are a black ink tank 16B for supplying black ink, and color ink tanks 16C, 16M and 16Y for supplying color inks of cyan, magenta, and yellow.

Ink transporting tubes 18 are connected the tank holder 15 on which those ink tanks are mounted to a first connection body 17 mounted on the upper side of the tank holder 15. The inks are supplied from the respective ink tanks to the first connection body 17 through the ink transporting tubes 18.

In the embodiment, an outer case of each ink tank, not shown in particular, is hermetically constructed. A flexible ink pack filled with ink is contained in each tank case. A pressurized air is supplied to the outer case forming the ink tank, whereby the ink is pushed out by the pressurized air.

A second connection body 10 is mounted also on the upper side of the carriage 1. The ends of an ink supplying tube 20 are connected to the first and second connection bodies 17 an 19 with the aid of connection members to be described later, respectively. With such an mechanical arrangement, the inks are supplied from the ink tanks to the carriage side, and the recording head ejects ink drops onto the recording sheet according to print data.

In the embodiment shown in FIG. 1, the ink supplying tube 20 is shaped into flat and long. The ink supplying tube 20 horizontally extends from the first connection body 17 in a state that its strip-like flat surface is put in a horizontal state. Further, the ink supplying tube is returned at a U-shaped bending part 20a thereof, and connected to the second connection body 19. The U-shaped bending part 20a of the ink supplying tube 20 successively moves in the longitudinal direction of the ink supplying tube, with movement of the carriage 1.

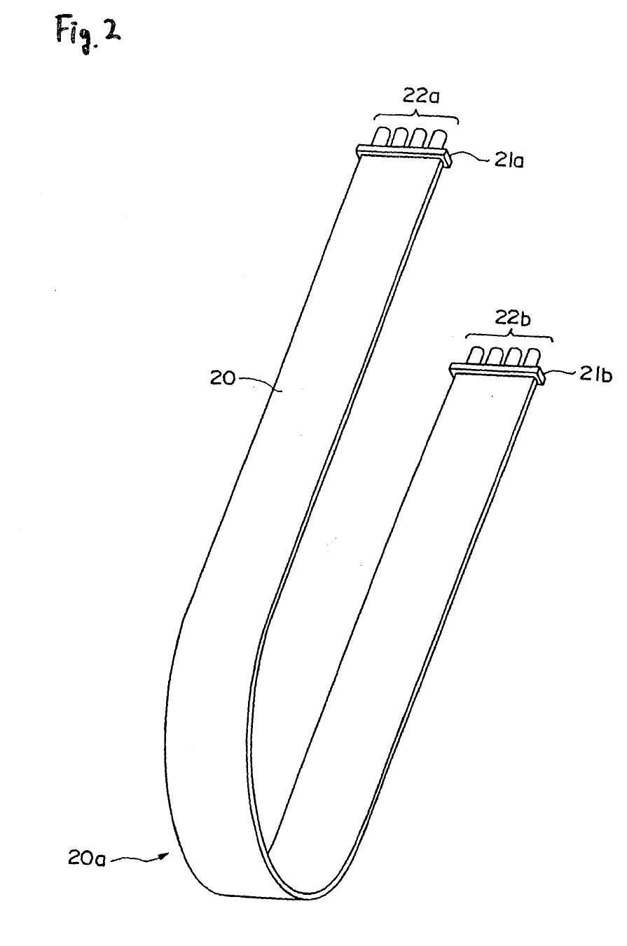

FIG. 2 is a perspective view showing an outward appearance of the ink supplying tube 20 used in the FIG. 1 recording device. First and second connection members 21a and 21b, made of synthetic resin, are attached to the ends of the ink supplying tube 20, respectively. In the embodiment, an arrangement is made to supply the inks from the four ink tanks 16B, 16C, 16M and 16Y, loaded to the tank holder 15, to the recording head. Accordingly, four connection pipes 22a and 22b, cylindrical in shape, are formed on the first connection members 21a and 21b.

The connection pipes 22a formed on the first connection member 21a are connected to the first connection body 17 shown in FIG. 1, and the four connection pipes 22b formed on the second connection member 21b are connected to the second connection body 19 show in FIG. 1. With such a connection configuration, the inks are supplied to the recording head 8 mounted on the carriage 1. Reference numeral 20a in FIG. 2 indicates a U-shaped bending part formed when the ink supplying tube 20 is actually used.

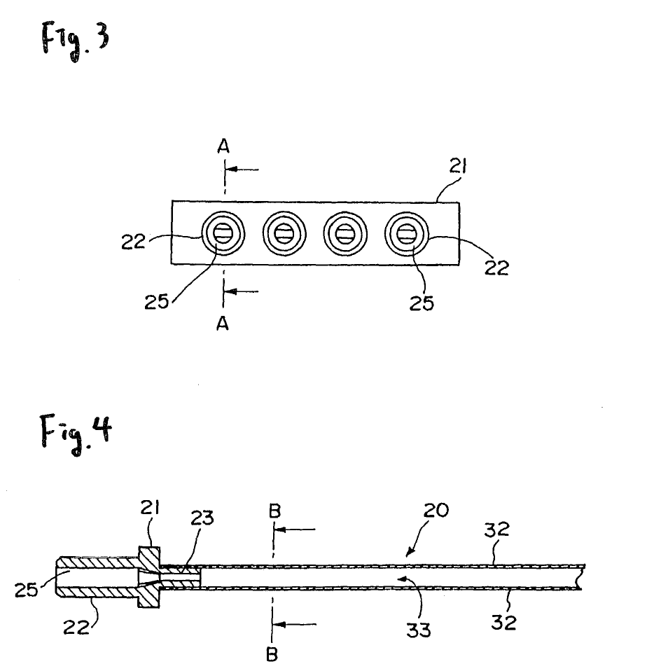

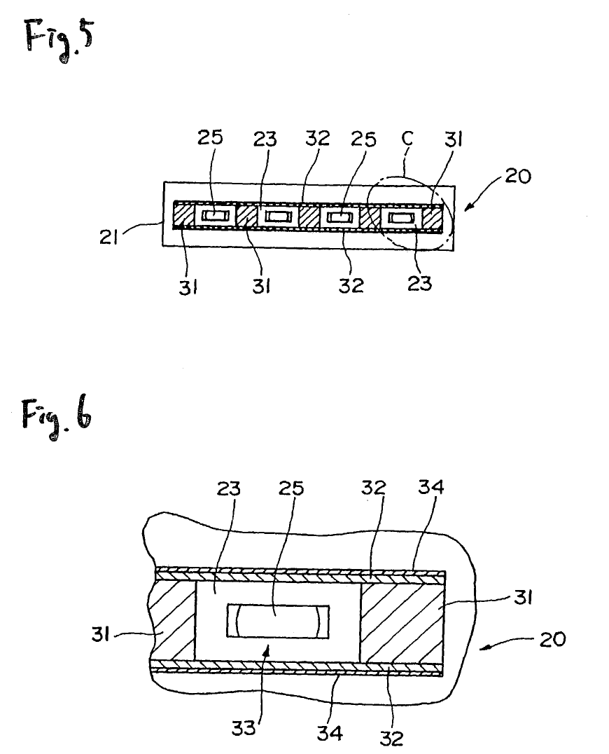

FIGS. 3 to 6 enlargedly show structures of portions of the ink supplying tube 20 whose outward appearance is shown in FIG. 2. FIG. 3 shows the first and second connection members 21a and 21b when viewed from the end side. FIG. 3 is a cross sectional view showing the ink supplying tube taken on line A-A in FIG. 3 and as viewed in a direction of an arrow. FIG. 5 is a cross sectional view showing the ink supplying tube taken on line B-B in FIG. 4 when viewed in a direction of an arrow. FIG. 6 is a cross sectional view showing a C part enclosed by a one-dot chain line in an enlarged fashion in FIG. 5. The first and second connection members 21a and 21b are configured to have the same shape. In this sense, those connection members are designated generally by reference numeral 21 in FIGS. 3 to 6. The cylindrical connection pipes formed on the connection members are also designated generally by reference numeral 22.

As shown in FIG. 5, the ink supplying tube 20 contains five elastic members 31, made of elastomer and molded to be long, which are arrayed at regular intervals in parallel. Film members 32, molded to have long lengths, are hermetically joined to one and the other surfaces, i.e., upper and lower surfaces, of the elastic members 31 made of elastomer by heat welding process.

Four spaces, which are defined by the adjacent elastic members 31 and the upper and lower film members 32, are used as ink supplying passages 33 as shown in FIG. 6. Those ink supplying passages 33 are separated by the elastic members 31, while being arrayed along the long flat surface. In this case, with use of elastomer in particular for the elastic members 31, the heat welding of a synthetic resin material constituting the elastomer to a synthetic resin material forming the film members 32 is made easy. Execution of the heat welding ensures a good hermeticity thereat.

In this case, a relatively elastic material may be selected for the elastomer. Accordingly, as shown in FIGS. 1 and 2, the flat surface of the ink supplying tube may smoothly be bent to be shaped like U. As a result, a degree of resistance of the ink supplying tube to the reciprocal motion of the carriage is remarkably reduced. As shown in FIG. 6, thin films 34 are formed, in advance, on the surfaces of the film members 32, which form the ink supplying tube 20, by an aluminum lamination process. With the use of the thin films, the gas barrier properties and the anti-water permeability of the ink supplying tube are effectively given to the ink supplying tube 20.

As shown in FIGS. 3 and 4, the connection member 21, which is mounted on each end of the ink supplying tube 20, includes a connection pipe 23, shaped like a square pole, which is located at a position opposed to each cylindrical connection pipe 22, shaped like a column or to be cylindrical. Openings 25 are formed in the connection member while passing through the cylindrical connection pipe 22 and the square pole like connection pipe 23. The square pole like connection pipe 23 is communicatively connected to the ink supplying passage 33 formed in the ink supplying tube 20 at each end of the ink supplying tube 20.

The square pole like connection pipe 23, as shown in FIG. 6, is heat welded at the upper and lower surfaces to the film members 32, and press fit, at both sides, to between the elastic members 31 of the elastomer. The side walls of the square pole like connection pipe 23, press fit to the elastic members 31, are preferably coated with adhesive in advance. By so doing, satisfactory hermeticity is kept between the side walls and the elastic members 31 after the fitting. In an alternative, the film member is made of a resin having the compatibility to the elastomer as the elastic material, and is made to integral with the elastomer by insert process, for example.

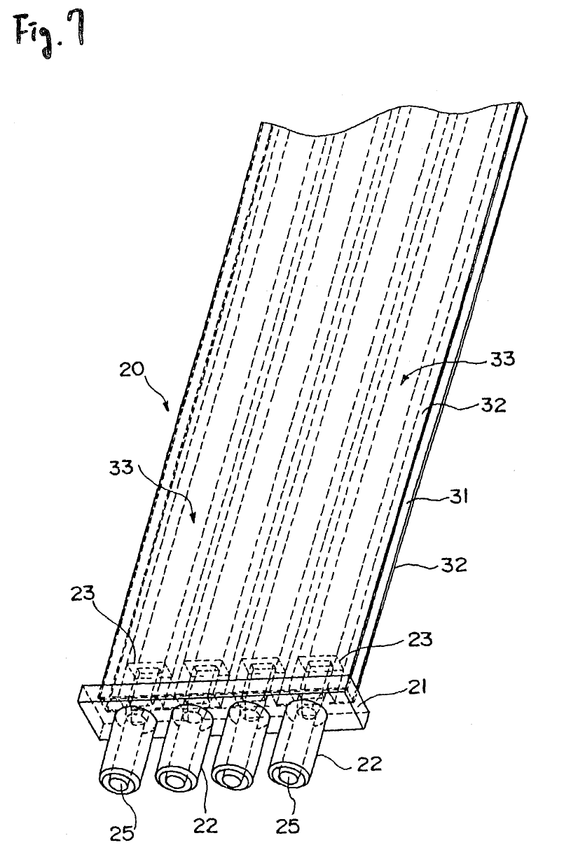

FIG. 7 perspectively shows a state that the connection member 21 are mounted on an end of the ink supplying tube 20. In the figure, like or equivalent portions are designated by like reference numerals used in the description already given.

Meanwhile, in the recording device of this type, or the off-carriage type, with the reciprocal movement of the carriage 1, the ink in the ink supplying tube receives an acceleration force. In this case, the acceleration force frequently causes the ink pressure to vary in the recording head. To cope with this, generally a damper member is mounted on the carriage in the recording device to thereby absorb a variation of the ink pressure.

In the ink supplying tube 20 described above, the ink supplying passages 33 are each surrounded by the elastic members 31 and the film members 32. With an elasticity of the film members 32 in particular, the damper function is secured. In this respect, the invention provides a recording device which is not provided with any special damper member by using the ink supplying tube 20.

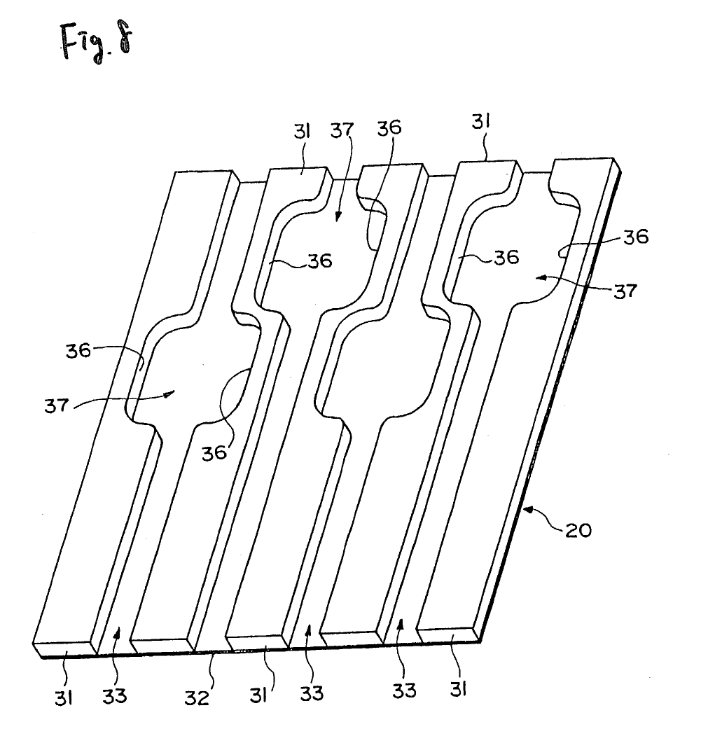

In the case of the ink supplying tube 20, there is a case where the damper function by the film members 32 is insufficient. To cope with this, as shown in FIG. 8, cutout portions 36 are formed at opposed positions of the elastic members 31. As a result, a space between the opposed positions of the elastic members 31 is increased to form an enlarged space 37. Incidentally, in FIG. 8, the ink supplying tube is illustrated in a state that the upper film member 32 is removed.

In the ink supplying tube thus constructed, broad areas resulting from presence of the enlarged spaces 37 are secured at portions of the ink supplying tube 20, whereby the damper function is effectively exhibited. The enlarged spaces 37 are preferably located at downstream positions of the ink supplying passages 33 of the ink supplying tube 20, viz., closer to the carriage 1.

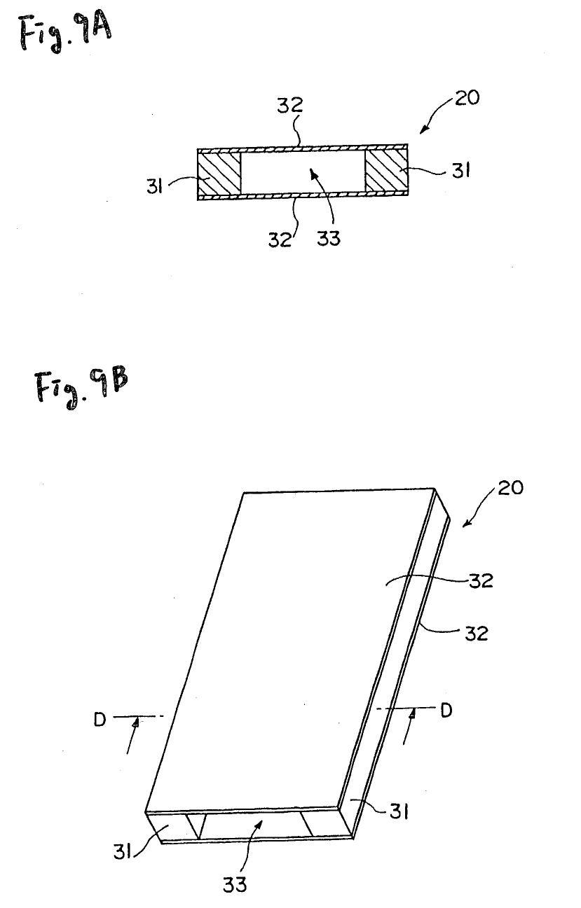

FIGS. 9A and 9B show an ink supplying tube according to the second embodiment. FIG. 9A is a cross sectional view taken on line D-D in FIG. 9B and as viewed in a direction of an arrow. FIG. 9B is a perspective view showing the ink supplying tube in a state that its size is reduced in its longitudinal direction. In the ink supplying tube 20 shown in FIGS. 9A and 9B, a couple of long, elastic members 31 are arrayed parallel to each other. The film members 32 are hermetically joined to one surface and the other surface of each elastic member 31. A space defined by the elastic members 31 and the film members 32 serves as an ink supplying passage 33.

Also in the ink supplying tube 20 shown in FIGS. 9A and 9B, it is preferable to use an elastomer for the elastic members 31, and to heat weld the film members 32 to the elastomer. Further, it is preferable to form thin films 34 on the outer sides of the upper and lower film members 32 by aluminum lamination process, as in the case shown in FIG. 6, although those thin films are not illustrated in FIGS. 9A and 9B.

Also in the ink supplying tube 20 shown in FIGS. 9A and 9B, first connection members made of a synthetic resin are mounted on both ends of the ink supplying tube. The ink supplying tube is connected between the first and second connection bodies 17 and 19 shown in FIG. 1. Ink is supplied from the ink tank to the recording head. In the embodiment shown in FIGS. 9A and 9B, one ink supplying passage is formed in one ink supplying tube 20. Accordingly, four ink supplying tubes 20 are independently utilized in the recording device shown in FIG. 1.

Also in the ink supplying tube 20 shown in FIGS. 9A and 9B, by selecting a relatively elastic material for the elastomer serving as the elastic member 31, a degree of resistance of the ink supplying tube to the reciprocal motion of the carriage is remarkably reduced. Further, when thin films are formed, in advance, on the surfaces of the film members 32, which form the ink supplying tube 20, by an aluminum lamination process, the gas barrier properties and the anti-water permeability are effectively given to the ink supplying tube 20.

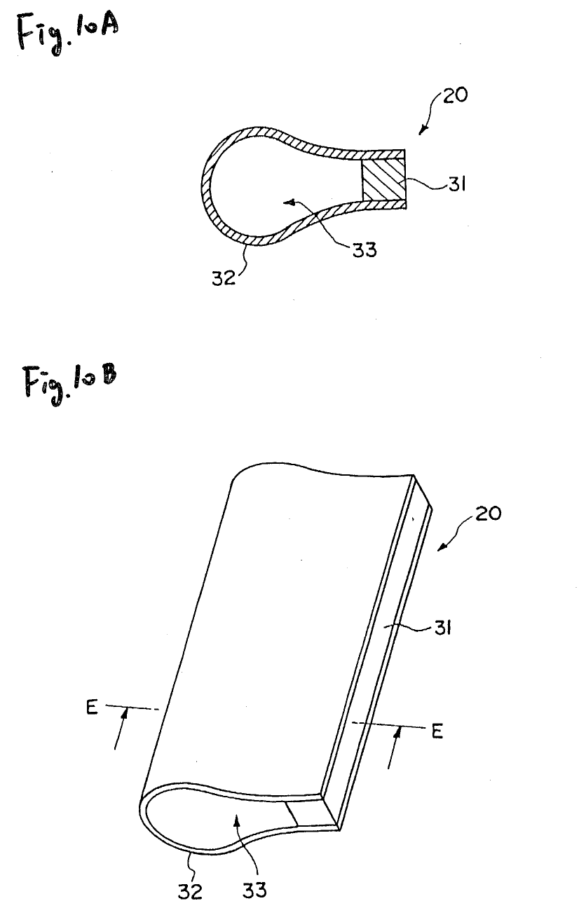

Finally, FIGS. 10A and 10B show an ink supplying tube according to the third embodiment. FIG. 10A is a cross sectional view taken on line E-E in FIG. 10B and as viewed in a direction of an arrow. FIG. 10B is a perspective view showing the ink supplying tube in a state that its size is reduced in its longitudinal direction. In the ink supplying tube 20 shown in FIGS. 10A and 10B, both ends of the film member 32 as viewed in a direction orthogonal to its longitudinal direction are hermetically joined to one surface and the other surface of the long elastic member 31, respectively.

The film member 32 is joined to both sides of the elastic member 31 in a bag shape to thereby form an ink supplying passage 33. With such a structure, of a peripheral length of the inner surface of the ink supplying passage 33, a part defined by the film member 32 is longer than a part defined by the elastic member 31, i.e., a thickness of the elastic member 31.

Also in the ink supplying tube 20 shown in FIGS. 10A and 10B, an elastomer is used for the elastic members 31, and the film member 32 is heat welded to the elastomer of the elastic member 31 in a bag shape, whereby those members are hermetically joined together. Further, it is preferable to form thin films 34 on the outer sides of the film member 32 by aluminum lamination process, as in the case shown in FIG. 6, although those thin films are not illustrated in FIGS. 10A and 10B.

Also in the ink supplying tube 20 shown in FIGS. 10A and 10B, first connection members made of a synthetic resin are mounted on both ends of the ink supplying tube. The ink supplying tube is connected between the first and second connection bodies 17 and 19 shown in FIG. 1. Ink is supplied from the ink tank to the recording head. In the embodiment shown in FIGS. 10A and 10B, one ink supplying passage is formed in one ink supplying tube 20. Accordingly, four ink supplying tubes 20 are independently utilized in the recording device shown in FIG. 1.

Also in the ink supplying tube 20 shown in FIGS. 10A and 10B, by selecting a relatively elastic material for the elastomer serving as the elastic member 31, a degree of resistance of the ink supplying tube to the reciprocal motion of the carriage is reduced. Further, when thin films are formed, in advance, on the surfaces of the film members 32, which form the ink supplying tube 20, by an aluminum lamination process, the gas barrier properties and the anti-water permeability are effectively given to the ink supplying tube 20.

In the above embodiments, the ink jet recording device (printing device including facsimile, copier and the like) for ejecting ink is used for the liquid jet device. The liquid jet device may eject another kind of liquid, as a matter of course. Examples of such devices are a liquid jet device for jetting liquid, e.g., electrode material or colorant, used in manufacturing LCD devices, EL display devices, FET (field emission display) devices, a liquid jet device for ejecting organic material used in manufacturing biological biochips, and a test sample jet device as an accurate pipette.

What is claimed is:

1. A liquid supplying tube for supplying liquid from a liquid tank to a liquid jet head mounted on a carriage, comprising:
at least one long elastic member, having a first face and a second face which are extended in a longitudinal direction thereof; and
at least one film member, hermetically joined to the first face and the second face of the elastic member so as to form a liquid supplying passage.

2. The liquid supplying tube as set forth in claim 1, wherein the at least one long elastic member is a pair of elastic members which are arrayed in parallel;
wherein the first face and the second face of the respective elastic members are opposite to each other; and
wherein the at least one film member is a pair of film members, and the film members are hermetically joined to the first faces and the second faces of the elastic members respectively.

3. The liquid supplying tube as set forth in claim 1, wherein the at least one long elastic member is a plurality of elastic members which are arrayed in parallel;
wherein the first face and the second face of the respective elastic members are opposite to each other; and
wherein the at least one film member is a pair of film members, and the film members are hermetically joined to the first faces and the second faces of the elastic members respectively.

4. The liquid supplying tube as set forth in claim 1, wherein a damper function portion is provided at a downstream side of the liquid supplying passage.

5. The liquid supplying tube as set forth in claim 4, wherein the damper function portion is formed so as to recess a part of the elastic member.

6. The liquid supplying tube as set forth in claim 1, wherein the film member is a stretch film member.

7. The liquid supplying tube as set forth in claim 1, wherein an inner face of the liquid supplying passage is constituted by a part of the film member and a part of the elastic member; and
wherein a peripheral length of the part of the film member is longer than the part of the elastic member in a cross section orthogonal to a longitudinal direction of the liquid supplying passage.

8. The liquid supplying tube as set forth in claim 1, wherein a thin film whose at least one of gas barrier properties and anti-water permeability is superior to that of the film member, are layered on the film member.

9. The liquid supplying tube as set forth in claim 1, wherein the elastic member is comprised of elastomer.

10. The liquid supplying tube as set forth in claim 1, wherein the film member is hermetically joined to the elastic member by heat welding process.

11. The liquid supplying tube as set forth in claim 1, further comprising a connection member which has an opening communicated with the liquid supplying passage; and
wherein the connection member is mounted to an end of the liquid supplying passage.

12. A liquid jet device, comprising:
a liquid tank, disposed on a main body of the liquid jet device;
a carriage, moving reciprocatively;
a liquid jet head, mounted on the cartridge; and
a liquid supplying tube, supplying liquid from the liquid tank to the liquid jet head, including:
at least one long elastic member, having a first face and a second face which are extended in a longitudinal direction thereof; and
at least one film member, hermetically joined to the first face and the second face of the elastic member so as to form a liquid supplying passage.

13. The liquid jet device as set forth in claim 12, wherein the at least one long elastic member is a plurality of elastic members which are arrayed in parallel;
wherein the first face and the second face of the respective elastic members are opposite to each other;
wherein the at least one film member is a pair of film members, and the film members are hermetically joined to the first faces and the second faces of the elastic members respectively; and
wherein the liquid supplying tube is connected the main body of the liquid jet device to the carriage in a state that a flat face of the liquid supplying tube is bent like U shape.
